(19) United States
(12) Patent Application Publication
(10) Pub. No.: US 2002/0015247 A1
(43) Pub. Date: Feb. 7, 2002

(54) HIGH RESOLUTION WIDE RANGE WRITE PRECOMPENSATION

(76) Inventors: DAVID S. ROSKY, GRASS VALLEY, CA (US); FULVIO SPAGNA, SAN JOSE, CA (US); JACK R. KNUTSON, FREEMONT, CA (US)

Correspondence Address: TEXAS INSTRUMENTS INCORPORATED, P O BOX 655474, M/S 3999, DALLAS, TX, 75265

(21) Appl. No.: 09/109,010

(22) Filed: Jul. 1, 1998

Related U.S. Application Data
(60) Provisional application No. 60/051,580, filed on Jul. 2, 1997.

(51) Int. Cl. G11B 5/09; G11B 5/02

(52) U.S. Cl. 360/45; 360/68

(57) ABSTRACT

A precompensation write circuit includes a ring oscillator (100), a pluse interpolator circuit 200, a data pattern sequence detector circuit 300, a precoder circuit 400, a data reference reframe circuit 500, a data coalscer circuit 600 and an isolation mux circuit 700.

### FIELD OF THE INVENTION

The invention relates to the field of integrated circuitry for writing data to a magnetic medium and more particularly to techniques for generating a precompensation delay in the path of a write data stream.

### BACKGROUND ART

In computer systems, information is stored on magnetic storage systems such as Winchester type hard disks or floppy disks. Data is stored in a series or spiral or concentric rings known as “tracks”. The data consists of streams of transitions of a polarity of magnetic particles on the disk surface. A number of schemes are used to detect these transitions and data.

One prior art, data detection method is a peak detection system. A disadvantage of peak detection schemes is limited to data density. Another prior art data scheme is known as partial-response class IV (PR-IV) signaling. Systems using these PR-IV schemes can achieve higher recording density than conventional peak detection systems.

A PRML (partial-response maximum likelihood) channel can be used to achieve high data density and writing and reading digital data of pulses on the disks. PRML coding assumes a linear channel. However, the recording characteristics of the magnetic medium such as a disk are nonlinear due to intersymbol interference (ISI).

Nonlinear distortion in the channel and consequently in the recording process on the magnetic medium leads to degradation at higher density and data rates. Narrow pulses in certain patterns of digital data signals experience pulse compression and other nonlinear pulse-edge displacement effects when stored magnetically on a disk file. This results in pattern dependent, edge shifts of the transition. The resulting data when read back from the disk has a higher error rate because of the nonlinear edge timing shifts of the pulses which reduce the timing margin for error of the data detection system. If the pattern-dependent edge shifts of the pulses can be ascertained for a particular medium, then it is possible to preshift the data write pulse edges by the amount equal opposite to the direction which the medium will shift them to eliminate the pattern dependent, edge shifts. As a result, data is written on the magnetic medium with the correct timing relationships read back from the disk. Timing precompensation solves the problem of pattern dependent, edge shifts and decreases error rates when the data is read back for accuracy and increases disk file capacity. Particular algorithms for determining which pulse edge to shift are well known and not described in detail. The amount of capacity improvement attainable for any algorithm depends on the accuracy of the time shifts delivered by the precompensation circuit.

User files are stored along these concentric tracks defined in magnetizable surface coatings on the surfaces of the rotating disk. To this end, during storage of the user file, user data is encoded and bits of encoded file are serially clocked to the write head driver that passes an electric current through a write head which is adjacent to a selected disk surface to magnetize segments of the selected data track in a pattern that reflects the sequence of logical values of bits that include the encoded user file. These magnetized segments, in turn, produce a magnetic field that can be sensed by a read head during reading to generate a sequence of electrical pulses that reflects the pattern of magnetization of the data track to permit recovery of the encoded file for decoding and are returned to the computer which makes use of the hard disc drive for another user file.

Write precompensation is a technique associated with the minimization or removal of the effects of nonlinear transitional shift (NLTS) that can occur in high density magnetic recording. Nonlinear transition shift is a write effect caused by magneto-static interactions that occur between closely spaced magnetic transactions. When adjacent magnetic transitions are recorded close together, NLTS causes a transition that immediately follows a preceding transition to be shifted or drawn toward the preceding transition such that the spacing of the median is altered from the ideal. When uncorrected, NLTS causes serious degradation of overall recording performance.

As magnetic recording densities become greater and greater, write precompensation techniques have become increasingly important to compensate for the detrimental effects of NLTS. Write precompensation involves delaying the times at which adjacently recorded transitions are written into a magnetic medium so that adjacent transitions are recorded were intended, for example, in proper bit spacing on the medium relative to the write clocking signal.

A write precompensation circuit “looks” at user data stream as it is written to the disk and detects the situation where two or more situations immediately follow each other without sufficient intervening bit times. The write precompensation circuit is able to adjust the relative delay (or phase with respect to the write clock) of the transition following a preceding transition in order to carry out necessary precompensation relative to the write clock signal. Application of precompensation delay causes the affected transitions to be time delayed by an appropriate amount, often expressed as a percentage of nominal bit cell period or a percentage of delay established by the write clock signal. With the emergence of PRML systems in magnetic requirement, nonlinear transition shift and write compensation becomes a particular concern.

A problem with previous precompensation write circuits is that the amount of time that the affected transition is delayed is insufficient. Previous precompensation write circuits could delay writing a pulse if the pulse only had a duration of one clock cycle but failed to adequately delay a write pulse if the write pulse extends over one clock pulse for example over two (a two level write pulse), three (a three level write pulse) or more.

### SUMMARY OF THE INVENTION

The present invention provides a precompensator for adjusting the delay time of the transitions affected by precompensation delay and being written to the disk recording surface with the timing adjustment being measured relative to the individual bit timing windows or individual clock pulses.

A digital ring oscillator may be formed of an interconnected ring of digital n stage ring oscillator (VCO) which includes at least one inverter gate and sometimes an odd number of inverter gates within the ring. This allows the percentage of delay to be incrementally adjusted for example in 2.5% increments. This provides flexibility in being able to react to varying time delays.

Additionally, the present invention can achieve the incremental delay at 100 ps at 250 MHz. The amount of the delay may be adjusted at the 2.5 increments up to 50%. These increments may be 2.5%, 5%, 7.5% . . . 40%, 42.5%, 45%, 47.5% and 50%.

Furthermore, the precompensation can be changed for each write clock pulse so that delay of corresponding transition can be selectively changed.

### BRIEF DESCRIPTION OF THE DRAWINGS

FIG. 1 illustrates an overall diagram of the present invention;

FIG. 2 illustrates various waveforms of the present invention;

FIG. 3 illustrates additional waveform of the present invention;

FIG. 4 illustrates a circuit diagram of the phase interpolator circuit;

FIG. 5 illustrates input waveforms for the circuit of FIG. 4;

FIG. 6 illustrates output waveform of the circuit of FIG. 4;

FIG. 7 illustrates a circuit diagram of the precoder circuit;

FIG. 8 illustrates a circuit diagram of the data pattern sequence detector;

FIG. 9 illustrates a circuit diagram of the data reference reframe circuit;

FIG. 10 is a circuit diagram of the data coalescer circuit;

FIG. 11 illustrates a circuit diagram of the isolation mux circuit;

FIG. 12 illustrates a circuit diagram of the write channel of the present invention;

FIG. 13 illustrates a ring oscillator of the present invention; and, FIG. 14 illustrates waveforms of the present invention.

### DETAILED DESCRIPTION OF THE INVENTION

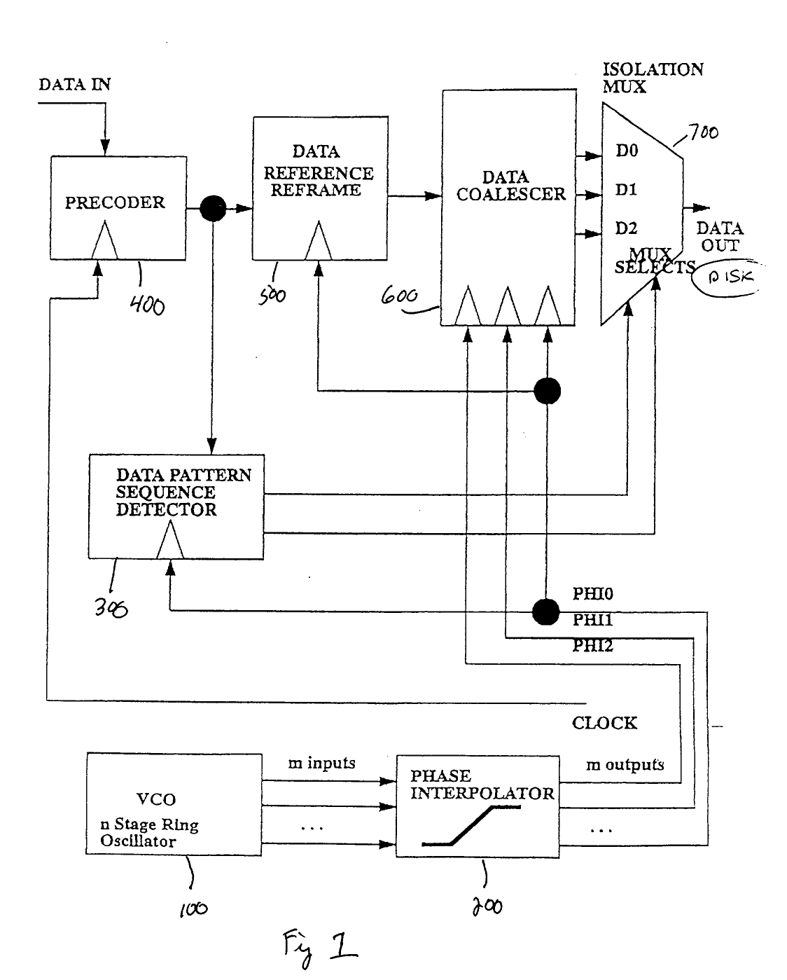

As illustrated in FIG. 1, an n stage ring oscillator 100, for example a VCO, is coupled to a phase interpolator circuit 200. FIG. 13 is a more detailed circuit design of the n stage ring oscillator 100. FIG. 13 illustrates an n-ring stage oscillator which does not require an input. This n stage ring oscillator 100 has two functional blocks. The plurality of multiplexers (102, 104, 106, . . .). The inputs of each multiplexer is connected to delay circuits (112, 114 . . . 116) the delay circuits (112, 114, 116) are connected in series. The output of delay circuit 112 is connected to the input of delay circuit 114 and multiplexer circuits (102, 104 . . . 106). Similarly, the output of delay circuit 114 is connected to multiplexer circuits (102, 104 . . . 106). Each multiplexer is controlled by a control signal bus which routes one of the N oscillator phases to the output. The phase interpolator circuit 200 is coupled to a data pattern sequence detector circuit 300 and a data reference reframe circuit 500. Additionally, the phase interpolator circuit 200 is coupled to a data coalescer circuit 600. Additionally, a precoder circuit 400 to receive the input data is coupled to the data reference reframe circuit 500. The data reference reframe circuit 500 is coupled to the data coalescer circuit 600. The data coalescer 600 is coupled to an isolation mux circuit 700.

The n stage ring oscillator circuit 100 outputs a ring output signal which includes multiple signals, for example M signals from the n stage ring oscillator 100. These M signals are at the same frequency but have a different phase. The ring output signal is input to the phase interpolator circuit 200. The phase interpolator circuit 200 outputs a phase signal for example, which may a plurality of differential signals. If six input signals are input to the phase interpolator 200, three output signals are output from the phase interpolator circuit 200: one corresponds to the zero phase signal, the second corresponds to another phase, and the third corresponds to yet another phase. The number of phases is equal to m/2. Each of these two signals are related in that they are differential signals. The zero phase signal is input to the data pattern sequence detector circuit 300, to an invertor coupled to the data reference reframe circuit 500 and to the data coalescer circuit 600. The zero phase signal is used as a clock for the data pattern sequence detector circuit 300 and the data coalescer circuit 600. The data reference reframe circuit 500 receives the inverse of the zero phase signal so that the data reference reframe circuit 500 retimes the data from the precoder circuit 400. The remaining phase signals, namely the one phase signal and two phase signal are additionally input to the data coalescer circuit 600.

A separate and independent clock signal is input into the precoder circuit 400. Additionally, the data to be written on disk is input to the precoder circuit 400. The precoder circuit 400 outputs a precoder output signal to both the data reference reframe circuit 500 and the data pattern sequence detector circuit 300. The data pattern sequence detector circuit 300 outputs a detector output signal which is input to the high isolation mux circuit 700 to select a particular output of the data coalescer circuit 600. The data reference reframe circuit 500 outputs a reframe output signal to data coalescer circuit 600. The data coalescer circuit 600 inputs the reference output signal and outputs a data coalescer signal. The coalescing output signal is input to the isolation mux circuit 700. The isolation mux circuit 700 outputs data to be written on the disk.

The data pattern sequence detector detects a pulse with the clock cycle separated by two zero pulses, for example, an isolated high pulse, or isolated low pulses and outputs a signal indicating that they have occurred.

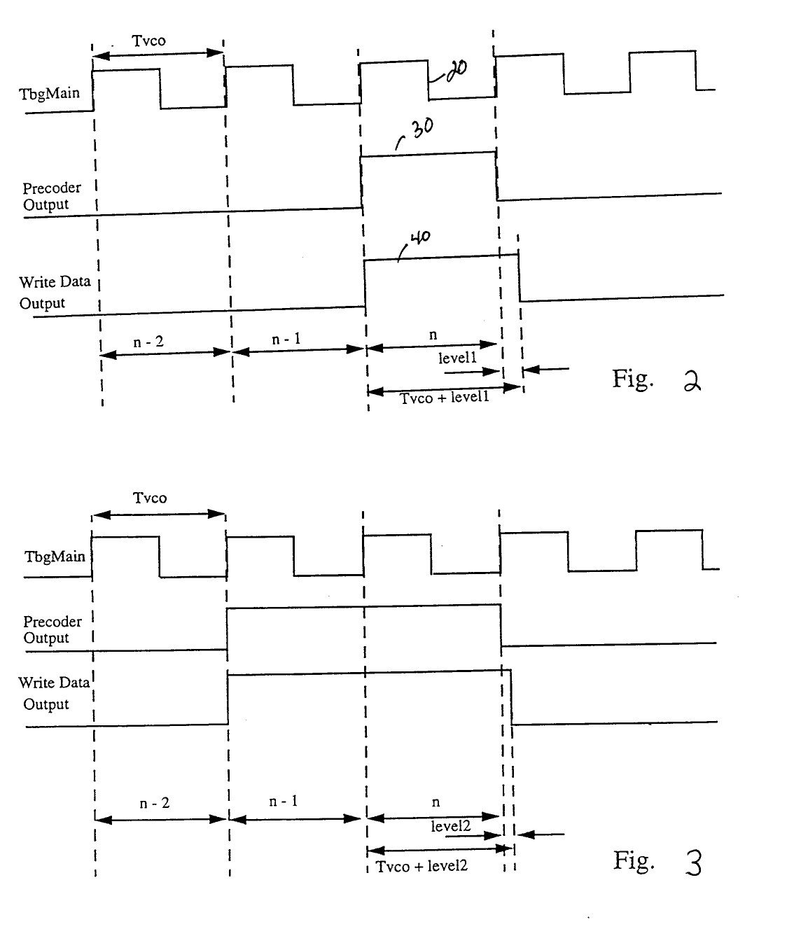

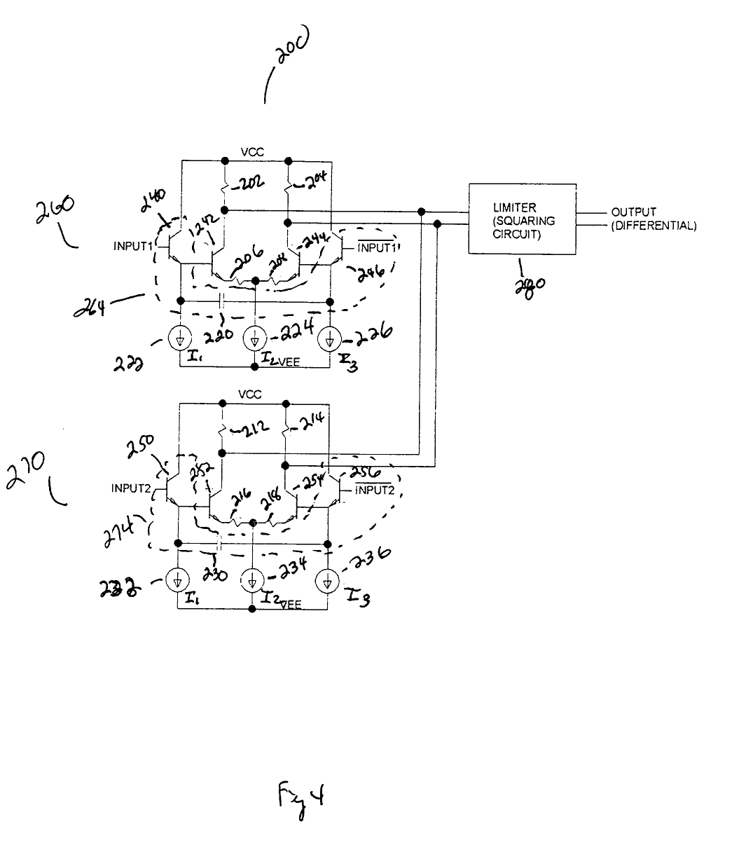

As illustrated in FIG. 14, the data pattern sequence detector maps user specified data sequences to one of the m/2 phases output by the phase interpolator. As an example, let's consider the case where M=6 and three phases are output by the phase interpolator, as a consequence three cases (patterns) must be programmed in the DPSD 300. The two cases shown in FIG. 2 & 3 associate (map) those sequences to phase 1 and 2 respectively; all the other patterns are associated to phase φ.

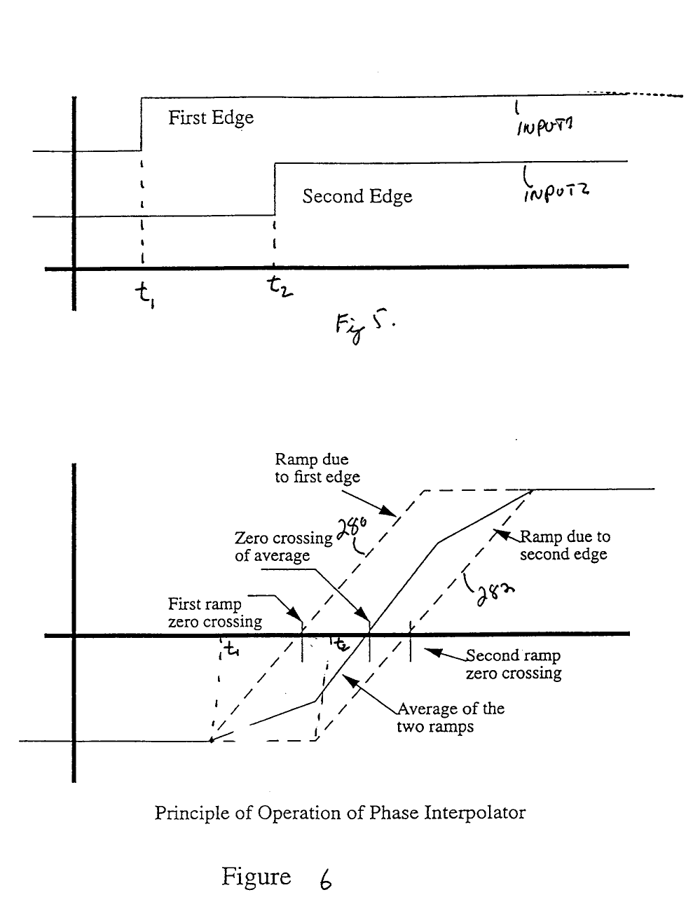

FIG. 4 illustrates a circuit diagram of the phase interpolator circuit 200. The phase interpolator circuit 200 interpolates two differential signals from the n stage ring oscillator 100. For each output stage of the n stage ring oscillator 100, a pair of differential signals is input to the phase interpolator circuit 200.

A circuit diagram of the phase interpolator circuit 200 is illustrated in FIG. 4. The phase interpolator circuit 200 includes a first interpolator circuit 260 for interpolating a first of two differential signals and a second interpolator circuit 270 for interpolating a second of the two differential signals. The first interpolator circuit 260 outputs a first interpolator signal which is input to a limiter circuit 280, for example, a squaring circuit 280. The second interpolator circuit 270 outputs a second interpolator signal to the limiter circuit 280. The first and second interpolator signals are each two differential signals which area summed by connection before input to the limiter circuit 280.

The first interpolator circuit 260 includes a first ramp generator 264, which includes switch 240, switch 246 and capacitor 220. The first input signal INPUT1 is input to the first ramp generator 264. Likewise, the second ramp generator 274 includes switch 250, switch 256 and capacitor 230, and the second ramp generator 274 inputs a second input signal INPUT2. The circuits operate identically. Additionally, the inverse of INPUT1 and INPUT2, namely INPUT1 and INPUT2 are also input to the first and second ramp generators 264 and 274, respectively.

The operation of the ramp generator is as follows.

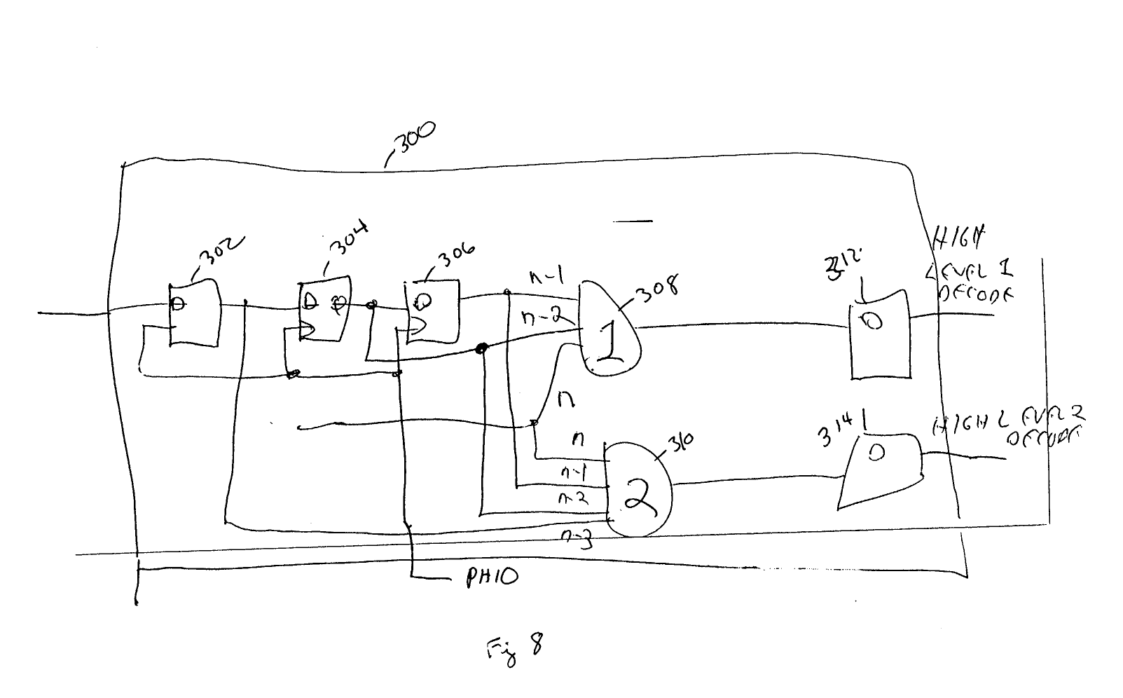

If the first input signal INPUT is initially at a low state and the inverse of the first input signal INPUT1 is initially at a high state, the emitter of switch 240 will be low and the emitter of switch 246 will be high. The capacitor 220 will be charged to a steady state voltage which is equal to the absolute difference between INPUT1 and INPUT1. When the first input signal INPUT1 and the second input signal INPUT1 switch state, for example, the first input signal INPUT1 goes from a low to a high state, and the inverse of the first input signal INPUT1 goes from a high to a low state, switch 246 turns off; switch 240 turns on; and the capacitor 220 begins discharging at a constant rate determined by the capacitance and the current I₁ from current source 222. This results in the voltage across the capacitor to be a linear voltage for example a ramping voltage with the slew rate of the ramp determined by the capacitance of capacitor 222 and the current I₁ through the current source 222. The switch 242 and switch 244 and resistor 206 and resistor 208 form a linear transconductance which generates a differential output current at the collectors of switch 224 and switch 244. This current is proportional to the voltage at the capacitor, which is ramping or increasing in an approximately linear manner as illustrated in FIG. 6. This aspect achieves the ramping. The two differential output currents from the two ramp generators for example, the collectors of transistors 206 and 208 and the collectors of transistors 252 and 254 respectively, then are summed together and converted to a voltage in the limiter 280. The currents could be summed by simply connecting the collectors of the transistors together as shown. The zero crossing of this summed waveform would be at a point halfway between the points where the phase of the input signals cross as illustrated in FIG. 6. This aspect of the circuit achieves the averaging of the ramp from the respective transition edges. This averaged signal rises too slowly to be used as a transition edge. A limiter circuit 280 significantly increases the slope of the ramp to the point where the a sharp or instantaneous transition occurs.

One apparatus to perform the transformation of the averaged signal is to employ a squaring circuit as the limiter circuit 280. The square of a ramp or linear increase is an impulse or a sharp or instantaneous transition and consequently achieves a fast rising and fast falling edges.

The limiter circuit 280 receives this averaged or summed signal as input and squares the input to increase the rising and falling edges where they are required by the circuitry which is clocked at the output of the phase interpolator.

The phase interpolator circuit 200 uses an analog phase interpolator to derive an intermediate clock phase from two adjacent output signals of the n stage VCO ring oscillator 100. Thus, the phase resolution that can be achieved at the φ interpolator from the n stage ring output 200 goes from TVCO/N to TVCO/2N. Since the phase interpolator circuit 200 generates a new clock phase which is approximately halfway between the two phases input from the n stage ring circuit 100.

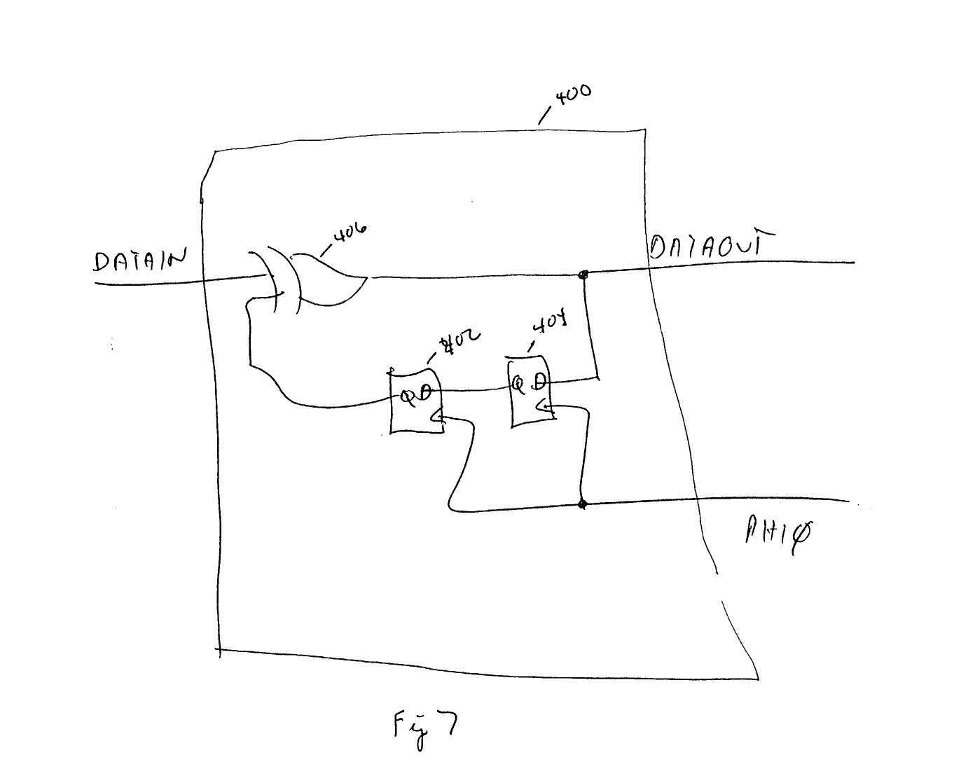

FIG. 5 illustrates two adjacent outputs from the n stage ring oscillator 100.

FIG. 5 illustrates that both digital inputs have a rising edge or transition. The first input INPUT1 is at the same frequency but different phase from the second input INPUT2. The transition of the first input INPUT1 is at t₁ while the transition of the second input INPUT2 is at t₂.

FIG. 6 illustrates that the first ramp signal 280 begins being generated at t₁ taking in to consideration the switch lines of the switches involved and the threshold voltages of the switches.

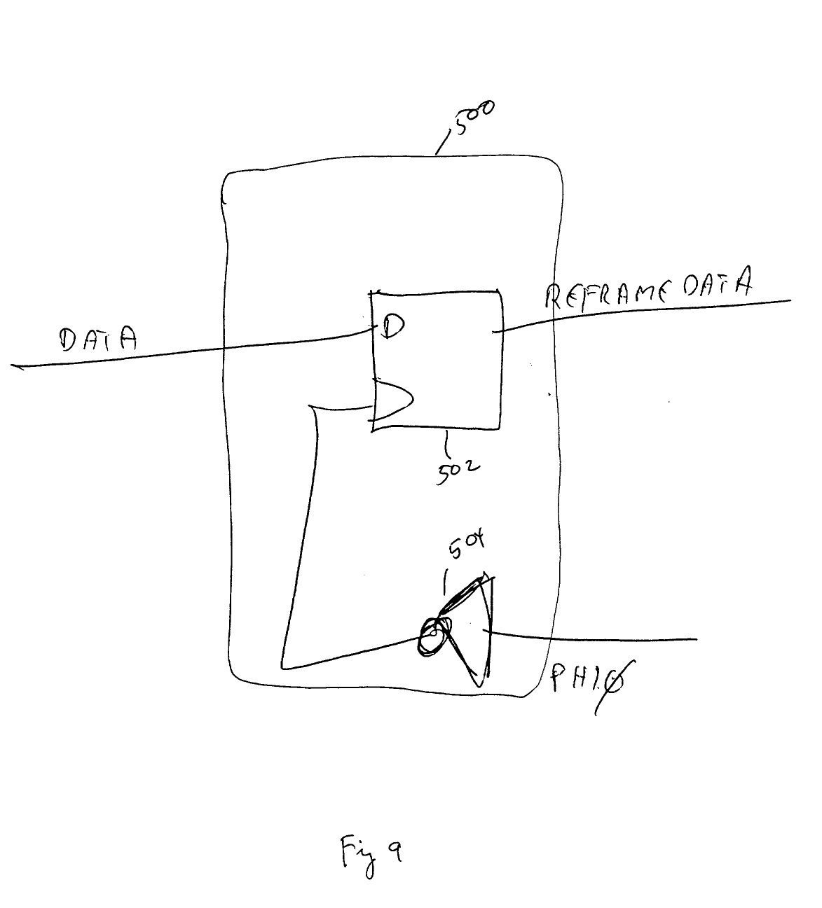

FIG. 7 illustrates a circuit diagram of the precoder circuit 400. A clock signal which may be the zero phase clock signal from the phase interpolator circuit 200 is input to flip-flop 402 and flip-flop 404. The zero phase clock signal is input to the reset input of the flip-flops 402 and 404. The flip-flop 404 additionally inputs the precoder output signal, which represents the delayed data output. The output of flip-flop 404, which corresponds to the input of flip-flop 404, is delayed up to a time corresponding to the clock signal, for example, the phase clock signal. The output of flip-flop 404 is input to flip-flop 402. The zero phase input signal is input to the reset input of flip-flop 402 Again, the output of flip-flop 402 is delayed up to the frequency of the clock signal, for example, the zero phase clock signal. The output of flip-flop 402 is input into AND gate 406 to logically ‘and’ the output data delayed with input data. The flip-flops 402 and 404 delay the data signal by, for example, two periods of the zero phase clock signal.

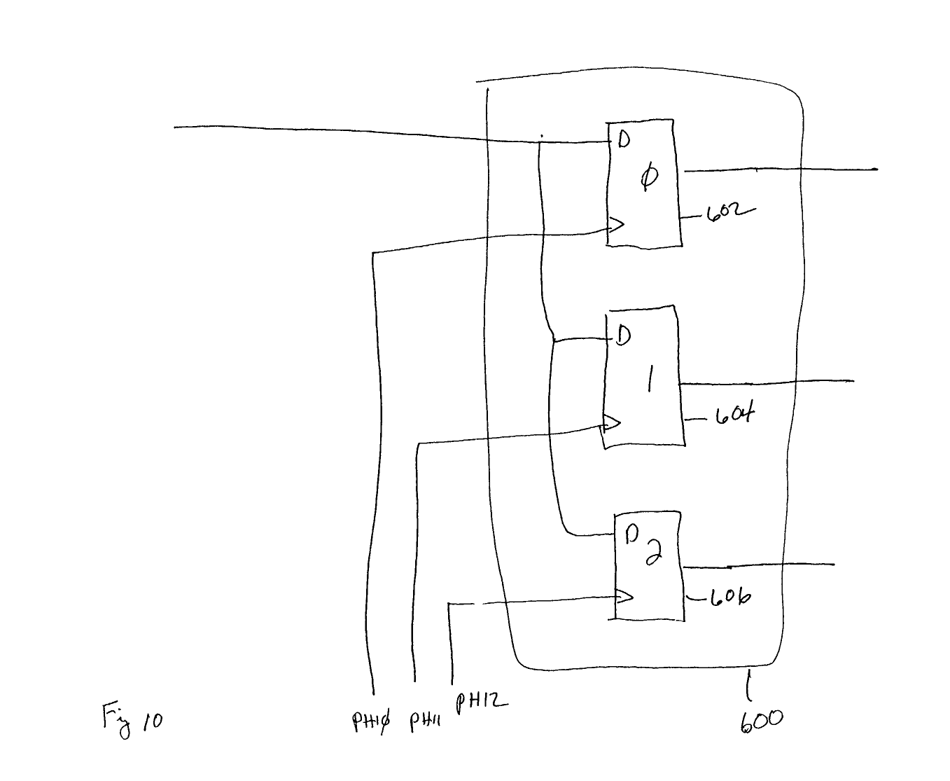

FIG. 8 illustrates a circuit diagram of the data pattern sequence detector circuit 300. The zero phase signal is input to the set/reset input of flip-flops 302, 304 and 306. This signal delays the data being transmitted through the data pattern sequence detector circuit 300. Additionally, data output from the precoder circuit is delayed by the flip-flops 302, 304 and 306. More specifically, each flip-flop delays the output of the previous flip-flop. The precoder output signal is input to flip-flop 302. As the zero phase signal is input to flip-flop 302, the flip-flop 302 outputs the precoder input signal to flip-flop 303. The signal for flip-flop 302 is input to AND gate 310. At the next zero phase signal, flip-flop 304 outputs the signal previously input from flip-flop 302 to flip-flop 306. The signal output from flip-flop 304 is input to AND gate 308 and AND gate 310. At the next and third zero phase signal, flip-flop 306 inputs the data signal output from flip-flop 304 to the AND circuit 308 and the AND circuit 309. Thus, N₁N-1 . . . N-3, refers to the time stamp (or time index) for the data stream. If the data under consideration is Xₙ.Xₙ₋₁. This is the previous data and so forth. Additionally, the output from flip-flop 304 is input directly to AND gate 308 and to AND gate 310 as the N-2 signal. Lastly, a N signal is input both to AND gate 308 and to AND gate 310. A logical AND operation is performed by AND circuit 310 on the outputs of flip-flips 302, 304, and 306. The output of AND circuit 310 is input to flip-flop 314. The output signals from flip-flop 302, 304 and 306 are input to AND circuit 308. The output of AND circuit 308 is input to flip-flop 312. The output from AND gate 310 is input to flip-flop 314. The output of flip-flop 312 indicates that the current data has been identified as a level 1 data (has been associated to phase 1). Similarly, a high at 314 indicates that the current data has been identified as level 2 (i.e. φ₂).

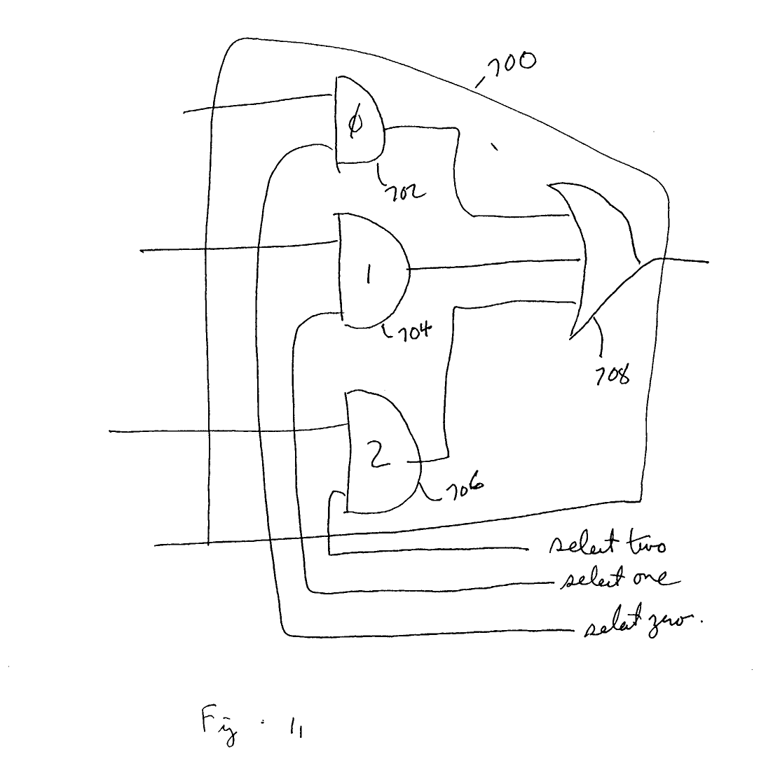

FIG. 9 illustrates the data reference reframe circuit 500. An inverter circuit 504 is connected to the set/reset input of a flip-flop 502. The zero phase signal is input to the inverter circuit 504. The output of the inverter 504 is an inverted zero phase signal; thus, the flip-flop 502 is activated by the positive edge of the inverted zero phase signal which is the negative edge of the zero phase signal, which was input to the inverter 504. Thus, when the zero phase signal is transformed such that the rising edges of the zero phase signal are transformed into falling edges and conversely the falling edges of the zero phase signal are converted to rising edges.

The precoder output signal is input to flip-flop circuit 502. This reframe output signal is output when the negative edge of the zero phase signal is received.

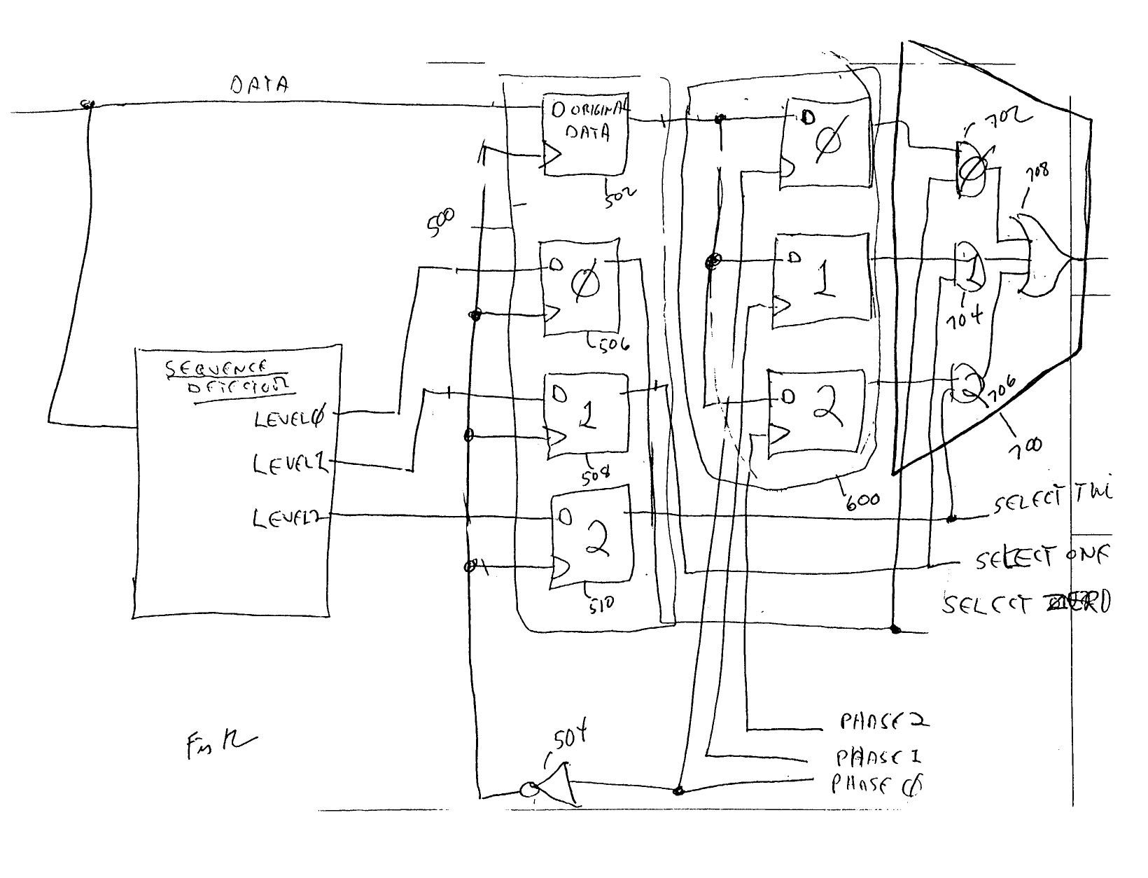

FIG. 10 illustrates the data coalescer circuit 600. As illustrated in FIG. 10, the data coalescer circuit 600 includes three flip-flops 602, 604 and 606 to delay the reference output signal based upon the zero one, two phase signals, respectively. The reference output signal is input to each flip-flop, namely flip-flop 602, flip-flop 604 and flip-flop 606. Flip-flop 602 inputs the zero phase signal into the set/reset input in order to time the output from the data reference reframe to the zero phase signal.

Likewise, flip-flop 604 inputs the one phase signal into set/reset input to time the output to one phase signal. Flip-flop 606 inputs the two phase signal into the set/reset input to time the output to the two phase signal.

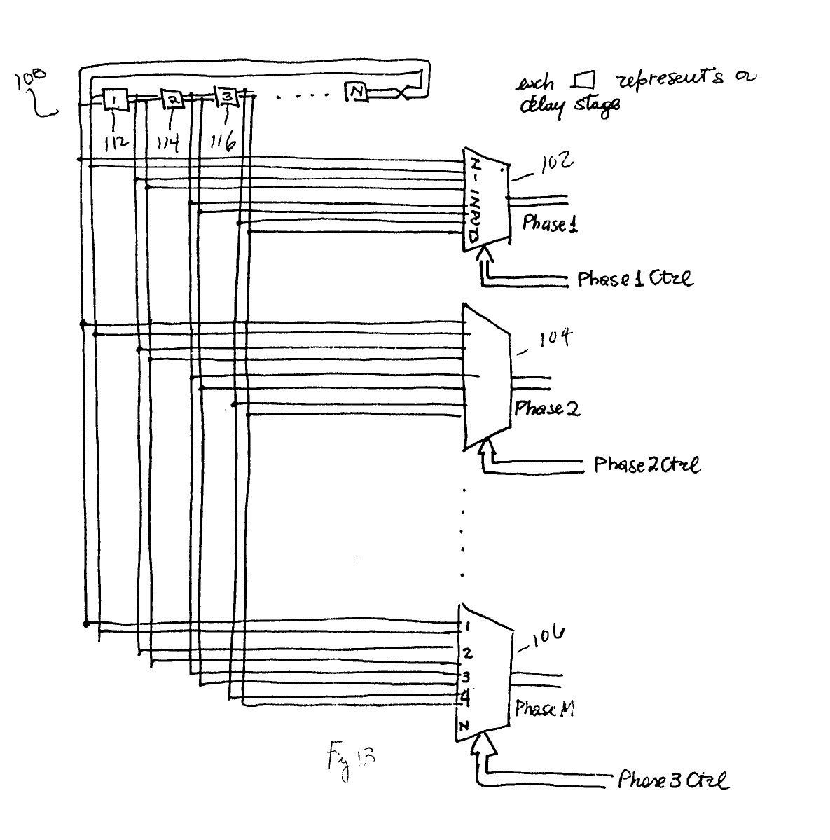

FIG. 11 illustrates the isolation mux circuit 700. The isolation mux circuit 700 includes a zero phase AND gate 702, a one phase AND circuit 704, and a two phase AND circuit 706. Additionally, the isolation mux circuit 700 includes an OR circuit 708 to logically OR the output of the zero phase AND circuit 702, the one phase AND circuits 704 and the two phase circuit 706. The zero phase AND circuit 702 is connected to the flip-flop 602 while the one phase AND circuit 704 is connected to the one phase flip-flop 604. The two phase AND circuit 706 is connected to the flip-flop 606. Additionally, a select zero signal is input to the zero phase AND circuit 702. A select one signal is input to the one phase AND circuit 704. Furthermore, a select two signal is input to the two phase AND circuit 706. The select signals are developed in the DPSD 300.

The select signals through the logical OR operation of the OR circuit 708 select the input signal that is output to the OR circuit 708. For example, the select zero signal selects the output of flip-flop 602 to be input to the OR circuit 708. Likewise, the select one signal selects the output of flip-flop 604 to be input to OR circuit 708, and the select two signal selects the output of flip-flop 606 to be input to the OR circuit 708.

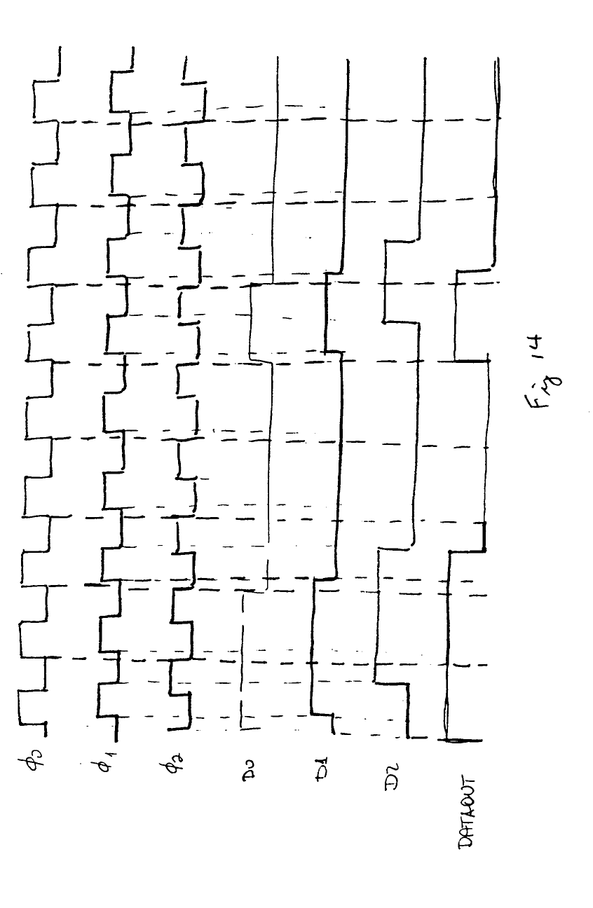

Additionally, as shown in FIG. 12, the data reference reframe circuit 500 includes a reframe zero phase flip-flop 506, a reference frame one phase flip-flop 508 and a reframe two phase flip-flop 510. Each of the reframe zero phase flip-flop 506, the reframe one phase flip-flop 508 and the reframe two phase flip-flop 510 is coupled to the output of the inverter 504 to be triggered at the set/reset input of the respective flip-flop, the inverse of the zero phase signal. This use of the inverse of the zero phase signal allows the present invention to achieve fifty percent precompensation range. Additionally, the reframe zero phase flip-flop 506 is connected to the sequence detector.

In operation, FIG. 1 illustrates that the n stage ring oscillator 100 outputs the ring output signals which are at the same frequency but out of phase from each other. These ring output signals are input to the phase interpolator circuit 200 which develops a outputs a zero phase signal, a one-phase signal and a two-phase signal. The zero phase signal is input to the data pattern sequence detector circuit 300. The precoder circuit 400 inputs data and a clock signal.

As illustrated in FIG. 7, the data is input through an exclusive OR circuit 406. The exclusive OR circuit outputs a precoder output signal, which is input to a series of delay circuit which are clocked at the zero phase signal, for example flip-flops 402 and 404. The output of the last flip-flop 404 is input to the exclusive OR circuit 406. Thus, the precoder output signal is input to the exclusive OR circuit 404 albeit delayed by the flip-flops 404 and 402. The precoder output signal is additionally input to the data pattern sequence detector 300.

As illustrated in FIG. 8, the precoder output signal is input to a series of flip-flops, for example flip-flop 302, flip-flop 304 and flip-flop 306. These flip-flops are activated by the zero phase signal. Thus, the precoder output signal is delayed as a result of progression through the flip-flops. The output of each respective flip-flop is input to AND gates 308 and 310, respectively. The output of AND gate 308 is input to flip-flop 312 while the output of flip-flop 310 is input to flip-flop 314.

Additionally, the precoder output signal is input to the data reference reframe circuit 500. As illustrated in FIG. 9, the zero phase signal is input to inverter 504 which inverts the signal to generate a positive edge from the negative edge of the zero phase signal. Thus, the precoder output circuit is retimed based on the inverse of the OR falling edge of the zero phase input signal. This provides for the percentage of delay to be up to 50%. Output from flip-flop 502 is the reference output signal which is input to data coalescer circuit 600.

As illustrated in FIG. 10, the data is input to flip-flop 602, flip-flop 604 and flip-flop 606. Additionally, the zero phase signal is input to the flip-flop 202 while the one phase signal is input to the flip-flop 604 and while the two phase signal is input to the flip-flop 606. Thus, output from the data coalescer circuit 600 is the reframe output signal delayed based upon the respective phase signals. These signals are input to the isolation mux 700. As illustrated in FIG. 4, each of the outputs from AND circuit 702, 704 and 706 are input to OR circuit 708. The select zero signal is input to AND circuit 702. The select one signal is input to the AND circuit 704 and the select two circuit is input to the AND circuit 706. Each of the AND circuits 702, 704 and 706 perform a logical AND operation between the inputs.

1. A write precompensator to achieve incremental delay up to 50% of a timing window.
